(19) United States
(12) Patent Application Publication
(10) Pub. No.: US 2021/0349407 A1
(43) Pub. Date: Nov. 11, 2021

(54) CYAN LIQUID ELECTROPHOTOGRAPHIC INK COMPOSITION

(71) Applicant: Hewlett-Packard Development Company, L.P., Spring, TX (US)

(72) Inventors: Adi Mann, Nes Ziona (IL); Albert Teishev, Nes Ziona (IL); Gilad Noy, Nes Ziona (IL)

(21) Appl. No.: 17/278,145

(22) PCT Filed: Dec. 6, 2018
(86) PCT No.: PCT/US2018/064231

§ 371 Date: Mar. 19, 2021

(51) Int. Cl. G03G 9/12; G03G 9/13; G03G 9/135; G03G 9/093; G03G 9/09; G03G 9/08

(52) U.S. Cl. CPC G03G 9/122; G03G 9/131; G03G 9/135; B82Y 40/00; G03G 9/0906; G03G 9/0823; G03G 9/093

(57) ABSTRACT

A method for producing a cyan liquid electrophotographic ink composition includes: dispersing in a first portion of carrier fluid cyan pigment particles and inorganic spacer particles, the inorganic spacer particles having a particle size (d50) of 0.1 μm or less, such that the inorganic spacer particles adhere to the cyan pigment particles; heating a polymer resin in a second portion of carrier fluid to dissolve the polymer resin; adding the dispersion of the cyan pigment particles having the inorganic spacer particles adhered thereto in the first portion of carrier fluid to the dissolved polymer resin in the second portion of carrier fluid; cooling the carrier fluid at a controlled rate to effect precipitation of the polymer resin from the carrier fluid such that a coating of the resin is formed on the cyan pigment particles having the inorganic spacer particles adhered thereto, thereby producing the cyan liquid electrophotographic ink composition.

### BACKGROUND

Electrostatic printing processes typically involve creating an image on a photoconductive surface, applying an ink having charged particles to the photoconductive surface, such that they selectively bind to the image, and then transferring the charged particles in the form of the image to a print substrate.

The photoconductive surface is typically on a cylinder and is often termed a photo imaging plate (PIP). The photoconductive surface is selectively charged with a latent electrostatic image having image and background areas with different potentials. For example, an electrostatic ink composition comprising charged toner particles in a carrier liquid can be brought into contact with the selectively charged photoconductive surface. The charged toner particles adhere to the image areas of the latent image while the background areas remain clean. The image is then transferred to a print substrate (e.g. paper) directly or, more commonly, by being first transferred to an intermediate transfer member, which can be a soft swelling blanket, and then to the print substrate.

Many substrates are white, and so the four printing inks used are cyan, magenta, yellow and black.

### BRIEF DESCRIPTION OF THE FIGURES

FIG. 1 shows the flow streak grading of printed inks as described herein; and

FIG. 2 shows optical density results of printed inks as described herein.

### DETAILED DESCRIPTION

Before the present disclosure is disclosed and described, it is to be understood that this disclosure is not limited to the particular process steps and materials disclosed herein because such process steps and materials may vary somewhat. It is also to be understood that the terminology used herein is used for the purpose of describing particular embodiments. The terms are not intended to be limiting because the scope is intended to be limited by the appended claims and equivalents thereof.

It is noted that, as used in this specification and the appended claims, the singular forms “a,” “an,” and “the” include plural referents unless the context clearly dictates otherwise.

As used herein, “carrier fluid”, “carrier liquid,” “carrier,” or “carrier vehicle” refers to the fluid in which polymers, pigment particles, colorant, charge directors and other additives can be dispersed to form a liquid electrostatic composition or electrophotographic composition. The carrier liquids may include a mixture of a variety of different agents, such as surfactants, co-solvents, viscosity modifiers, and/or other possible ingredients.

As used herein, “electrostatic ink composition” or “liquid electrophotographic composition” generally refers to an ink composition that is typically suitable for use in an electrostatic printing process, sometimes termed an electrophotographic printing process. It may comprise pigment particles, which may comprise a thermoplastic resin.

As used herein, “co-polymer” refers to a polymer that is polymerized from at least two monomers.

A certain monomer may be described herein as constituting a certain weight percentage of a polymer. This indicates that the repeating units formed from the said monomer in the polymer constitute said weight percentage of the polymer.

As used herein, “electrostatic printing” or “electrophotographic printing” generally refers to the process that provides an image that is transferred from a photo imaging substrate either directly, or indirectly via an intermediate transfer member, to a print substrate. As such, the image is not substantially absorbed into the photo imaging substrate on which it is applied. Additionally, “electrophotographic printers” or “electrostatic printers” generally refer to those printers capable of performing electrophotographic printing or electrostatic printing, as described above. “Liquid electrophotographic printing” is a specific type of electrophotographic printing where a liquid ink is employed in the electrophotographic process rather than a powder toner. An electrostatic printing process may involve subjecting the electrostatic ink composition to an electric field, e.g. an electric field having a field gradient of 50-400V/μm, or more, in some examples 600-900V/μm, or more, in some examples 1000 V/cm or more, or in some examples 1500 V/cm or more.

As used herein, “melt flow rate” generally refers to the extrusion rate of a resin through an orifice of defined dimensions at a specified temperature and load, usually reported as temperature/load, e.g. 190° C./2.16 kg. Flow rates can be used to differentiate grades or provide a measure of degradation of a material as a result of molding. In the present disclosure, “melt flow rate” is measured per ASTM D1238-04c Standard Test Method for Melt Flow Rates of Thermoplastics by Extrusion Plastometer, as known in the art. If a melt flow rate of a particular polymer is specified, unless otherwise stated, it is the melt flow rate for that polymer alone, in the absence of any of the other components of the electrostatic composition.

As used herein, “acidity,” “acid number,” or “acid value” refers to the mass of potassium hydroxide (KOH) in milligrams that neutralizes one gram of a substance. The acidity of a polymer can be measured according to standard techniques, for example as described in ASTM D1386. If the acidity of a particular polymer is specified, unless otherwise stated, it is the acidity for that polymer alone, in the absence of any of the other components of the liquid toner composition.

As used herein, “melt viscosity” generally refers to the ratio of shear stress to shear rate at a given shear stress or shear rate. Testing is generally performed using a capillary rheometer. A plastic charge is heated in the rheometer barrel and is forced through a die with a plunger. The plunger is pushed either by a constant force or at constant rate depending on the equipment. Measurements are taken once the system has reached steady-state operation. One method used is measuring Brookfield viscosity @ 140° C., units are mPa-s or cPoise, as known in the art. Alternatively, the melt viscosity can be measured using a rheometer, e.g. a commercially available AR-2000 Rheometer from Thermal Analysis Instruments, using the geometry of: 25 mm steel plate-standard steel parallel plate, and finding the plate over plate rheometry isotherm at 120° C., 0.01 Hz shear rate. If the melt viscosity of a particular polymer is specified, unless otherwise stated, it is the melt viscosity for that polymer alone, in the absence of any of the other components of the electrostatic composition.

Unless otherwise stated, the particle size of the pigment particle and the coated pigment particle refers to a volume equivalent spherical diameter and is determined using laser diffraction on a Malvern Mastersizer 2000 according to the standard procedure as described in the operating manual.

As used herein, “particle size (d50)” of the inorganic spacer particle refers to the mass median equivalent spherical diameter of a particle size distribution as measured using the Sedigraph method of particle sizing.

As used herein, “(cyan) pigment particle” may refer to one pigment exhibiting a cyan colour, or may refer to a combination of different pigments which in combination exhibit a cyan colour, for example a blend of blue and green pigments.

As used herein, “coated (cyan) pigment particle” generally refers to a polymer resin coating or encapsulating a cyan pigment particle having one or more inorganic spacer particles adhered to the surface of the pigment particle.

As used herein, “low field conductivity” refers to the electrical conductivity of an ink and is measured by applying a constant amplitude AC voltage to two parallel electrodes and monitoring the current via the fluid. Since the conductivity per definition is proportional to the current and inversely proportional to the voltage inducing the current, the conductivity can be calculated by multiplying the current by a factor depending only on the constant values of the voltage amplitude and geometric parameters, i.e. electrodes surface and distance between the electrodes. The present low field conductivities were measured at the following conditions: electrical field amplitude: 5-15 V/mm, frequency: 5-15 Hz, and temperature: 23+/−2 C.

As used herein, “high field conductivity” refers to the maximum electrical conductivity of the ink measured at the following conditions: electrical field pulse—shape: rectangular; height: 1500 V/mm; duration: 8 sec, rise time: 1 ms or less; ripple: 10 V/mm or less; sampling frequency: 1000 per second; and temperature: 23+/−2 C.

As used herein, “direct conductivity” refers to the average conductivity of the ink measured between 6.4 and 7.2 seconds and was measured by applying a constant high voltage to two parallel electrodes and monitoring the current via the fluid. Since the conductivity per definition is proportional to the current and inversely proportional to the voltage inducing the current, the conductivity can be calculated by multiplying the current by a factor depending only on the constant values of the voltage amplitude and geometric parameters, i.e. electrodes surface and distance between the electrodes. The conductivity of the ink measured in constant electrical field is varying (actually declining) with time. As such, the maximum value of the conductivity is defined as the “high field conductivity” as noted above, and the “direct conductivity” is the conductivity at the tail of the conductivity vs. time curve when the conductivity has leveled off.

As used herein, “particle conductivity” refers to the difference between the high field conductivity and the low field conductivity as defined above. The particle conductivity is proportional to the ink particle properties; i.e., mobility and electrical charge created on the particles.

If a standard test is mentioned herein, unless otherwise stated, the version of the test to be referred to is the most recent at the time of filing this patent application.

As used herein, “NVS” is an abbreviation of the term “non-volatile solids”.

As used herein, “cooling without restriction” or “cooling at an uncontrolled rate” generally refers to cooling at a rate faster than about 10° C./hour, for example at least about 20° C./hour, and may include cooling via heat exchange with one or more cooling fluids or refrigerants. In contrast, and as used herein, “cooling at a controlled rate” generally refers to cooling at a rate of between 2 and 7° C. Cooling at a controlled rate may also include cooling via heat exchange with one or more cooling fluids or refrigerants.

As used herein, the term “about” is used to provide flexibility to a numerical range endpoint by providing that a given value may be a little above or a little below the endpoint to allow for variation in test methods or apparatus. The degree of flexibility of this term can be dictated by the particular variable and would be within the knowledge of those skilled in the art to determine based on experience and the associated description herein.

As used herein, a plurality of items, structural elements, compositional elements, and/or materials may be presented in a common list for convenience. However, these lists should be construed as though each member of the list is individually identified as a separate and unique member. Thus, no individual member of such list should be construed as a de facto equivalent of any other member of the same list solely based on their presentation in a common group without indications to the contrary.

Concentrations, amounts, and other numerical data may be expressed or presented herein in a range format. It is to be understood that such a range format is used merely for convenience and brevity and thus should be interpreted flexibly to include not just the numerical values explicitly recited as the limits of the range, but also to include all the individual numerical values or sub-ranges encompassed within that range as if each numerical value and sub-range is explicitly recited. As an illustration, a numerical range of “about 1 wt % to about 5 wt %” should be interpreted to include not just the explicitly recited values of about 1 wt % to about 5 wt %, but also include individual values and subranges within the indicated range. Thus, included in this numerical range are individual values such as 2, 3.5, and 4 and sub-ranges such as from 1-3, from 2-4, and from 3-5, etc. This same principle applies to ranges reciting a single numerical value. Furthermore, such an interpretation should apply regardless of the breadth of the range or the characteristics being described.

As used herein, wt % values are to be taken as referring to a weight-for-weight (w/w) percentage of solids in the ink composition, and not including the weight of any carrier fluid present.

Unless otherwise stated, any feature described herein can be combined with any aspect or any other feature described herein.

In an aspect there is provided a method for producing a cyan liquid electrophotographic ink composition, the method comprising:
dispersing in a first portion of carrier fluid cyan pigment particles and inorganic spacer particles, the inorganic spacer particles having a particle size (d50) of 0.1 μm or less, such that the inorganic spacer particles adhere to the cyan pigment particles;
heating a polymer resin in a second portion of carrier fluid to dissolve the polymer resin;
adding the dispersion of the cyan pigment particles having the inorganic spacer particles adhered thereto in the first portion of carrier fluid to the dissolved polymer resin in the second portion of carrier fluid;
cooling the carrier fluid at a controlled rate to effect precipitation of the polymer resin from the carrier fluid such that a coating of the resin is formed on the cyan pigment particles having the inorganic spacer particles adhered thereto, thereby producing the cyan liquid electrophotographic ink composition.

In another aspect there is provided a cyan pigment particle, comprising:
a cyan pigment;
an inorganic spacer particle having a particle size (d50) of 0.1 μm or less associated with the cyan pigment; and
a polymer resin encapsulating the cyan pigment and inorganic spacer particle.

In another aspect there is provided a cyan liquid electrophotographic ink composition, comprising:
a carrier fluid; and
a cyan pigment particle;
wherein the cyan pigment particle comprises
   a cyan pigment;
   an inorganic spacer particle having a particle size (d50) of 0.1 μm or less associated with the cyan pigment; and
   a polymer resin encapsulating the cyan pigment and inorganic spacer particle.

In another aspect there is provided a cyan electrophotographic ink composition producible in accordance with a method comprising:
dispersing in a first portion of carrier fluid cyan pigment particles and inorganic spacer particles, the inorganic spacer particles having a particle size (d50) of 0.1 μm or less, such that the inorganic spacer particles adhere to the cyan pigment particles;
heating a polymer resin in a second portion of carrier fluid to dissolve the polymer resin;
adding the dispersion of the cyan pigment particles having the inorganic spacer particles adhered thereto in the first portion of carrier fluid to the dissolved polymer resin in the second portion of carrier fluid;
cooling the carrier fluid at a controlled rate to effect precipitation of the polymer resin from the carrier fluid such that a coating of the resin is formed on the cyan pigment particles having the inorganic spacer particles adhered thereto, thereby producing the cyan liquid electrophotographic ink composition.

Much research has been carried out in recent years to improve electrostatic printing inks. Electrostatic printing inks have been produced, e.g. by grinding a pigment with a resin, sometimes in the presence of a liquid carrier. However, this is an energy intensive process, and some of such inks have been found to have a high level of background when printed, result in a low lifespan of binary ink development units, photoimaging plate and intermediate transfer members, sometimes form streaks on printing, print at relatively high voltages and currents, and/or sometimes display non-electrostatic ink-like behaviour. The present inventors have found that examples of the method as described herein avoid or at least mitigate at least one of the difficulties described above. They have found that examples of the method are more successful in encapsulating cyan pigment particles and that the pigment particles have less of a tendency to deform during the production process.

Cyan Pigment

Although a variety of pigments may be used, in one example the pigment is a cyan pigment. In some examples, the pigment may comprise a particle of a pigment that exhibits a cyan colour. In some examples, the pigment may comprise a blend of pigment particles which in combination exhibit a cyan colour. For example, the pigment may comprise a blend of blue and green pigment particles. Cyan colour may be produced from a phthalocyanin and includes pigments selected from pigment blue 15:0, pigment blue 15:1, pigment blue 15:2, pigment blue 15:3, pigment blue 15:4, pigment blue 15:6, pigment blue 16, pigment blue 17, pigment blue 17.1, pigment blue 27, pigment blue 60, pigment blue 66, pigment blue 73, pigment blue 75, pigment blue 76, pigment blue 79, and any combination thereof. Examples of blue and green pigments that can be blended to exhibit a cyan colour are pigment blue 15:3 and pigment green 7, and the LIONOL BLUE FG-7351 pigment from Toyo and the Heliogen® Green D 8730 from BASF. It will be understood that other green and blue pigments are known to produce a cyan colour for printing inks and that the exact pigments and proportions of pigments in a blend may vary depending on the shade of cyan required.

In some examples, the pigment particles are surface treated pigment particles. For example, the pigment particles may be organic surface treated or inorganic surface treated. In some examples, the pigment particles are surface treated to provide them with an increased hydrophobicity. In some examples, the pigment particles are surface treated with a modified polysiloxane to provide increased hydrophobicity.

In some examples, the uncoated pigment particles may have a median particle size or d₅₀ of less than 20 μm, for example less than 15 μm, for example less than 10 μm, for example less than 5 μm, for example less than 4 μm, for example less than 3 μm, for example less than 2 μm, for example less than 1 μm, for example less than 0.9 μm, for example less than 0.8 μm, for example less than 0.7 μm, for example less than 0.6 μm, for example less than 0.5 μm. Unless otherwise stated, the particle size of the pigment particle and the coated pigment particle is determined using laser diffraction on a Malvern Mastersizer 2000 according to the standard procedure as described in the operating manual.

The pigment particle may be present in the method and/or electrostatic ink composition in an amount of from 10 wt % to 80 wt % of the total solids of the composition, in some examples 15 wt % to 80 wt %, in some examples 15 wt % to 60 wt %, in some examples 15 wt % to 50 wt %, in some examples 15 wt % to 40 wt %, in some examples 15 wt % to 30 wt % of the total solids of the composition. In some examples, the pigment particle may be present in the method and/or electrostatic ink composition in an amount of at least 50 wt % of the total solids of the composition, for example at least 55 wt % of the total solids of the composition.

In some examples, the pigment particle is present in a first portion of the carrier fluid in an amount of from 2 wt % to 50 wt % of the total weight of the first portion of the carrier fluid, including the inorganic spacer particle and any other additives. In some examples, the pigment particle is present in a first portion of the carrier fluid in an amount of from 2 wt % to 40 wt %, for example from 10 wt % to 30 wt %, for example from about 20 wt % to 30 wt % of the total weight of the first portion of the carrier fluid, including the inorganic spacer particle and any other additives.

In some examples, the cyan pigment particle comprises the cyan pigment, an inorganic spacer particle having a particle size (d50) of 0.1 μm or less associated with or adhered to the surface of the pigment and a polymer resin encapsulating the cyan pigment and inorganic spacer particle.

In some examples, the encapsulated pigment particles may have a median particle size or d₅₀ of less than 25 μm, for example less than 15 μm, for example less than 10 μm, for example less than 5 μm, for example less than 4 μm, for example less than 3 μm, for example less than 2 μm, for example less than 1 μm, for example less than 0.9 μm, for example less than 08 μm, for example less than 0.7 μm, for example less than 0.6 μm, for example less than 0.5 μm.

Inorganic Spacer Particle

In some examples, the methods and ink compositions of the present disclosure include an inorganic spacer particle. The inorganic spacer particle adheres to the surface of the pigment particle, increases the effective diameter of the pigment particle while not allowing flocculation or agglomeration of pigment particles. The inorganic spacer particle is chemically inert, and adheres to the surface of the pigment particle via intermolecular forces (i.e. van der Waals forces) rather than through any covalent bond.

In some examples, the inorganic spacer particle has a particle size (d50) of less than about 0.1 μm, for example less than about 0.09 μm, for example less than about 0.08 μm, for example less than about 0.07 μm, for example less than about 0.06 μm, for example less than about 0.05 μm, for example about 0.04 μm. In some examples, the inorganic spacer particle has a particle size (d50) greater than about 0.04 μm, for example greater than about 0.05 μm, for example greater than about 0.06 μm, for example greater than about 0.07 μm, for example greater than about 0.08 μm, for example greater than about 0.09 μm, or for example greater than about 0.1 μm. In some examples, the inorganic spacer particle has a particle size (d50) in the range of from 0.04 to 0.1 μm.

In some examples, the inorganic spacer particle is present in the first portion of the carrier fluid in an amount of less than about 20 wt % based on the total solids content of the dispersion, for example in an amount of less than about 15 wt %, for example less than about 10 wt %, for example less than about 5 wt %, for example less than about 2 wt % based on the total solids content of the dispersion. In some examples, the inorganic spacer particle is present in the first portion of the carrier fluid in an amount of greater than about 2 wt % of the total solids content of the dispersion, for example greater than about 5 wt %, for example greater than about 10 wt %, for example greater than about 15 wt %, for example about 20 wt % based on the total solids content of the dispersion.

In some examples, the inorganic spacer particle has a refractive index of less than 2, for example less than 1.9, for example less than 1.8, for example less than 1.7 for example less than 1.6, for example less than 1.5, for example less than 1.4. In some examples, the inorganic spacer particle has a refractive index in the range of from 1.4 to 2, for example from 1.5 to 1.9, for example from 1.6 to 1.8. A refractive index in this range ensures that the spacer particle has a refractive index lower than that of the pigment and so remains transparent and does not affect the cyan colour of the encapsulated pigment and thus the ink composition.

In some examples, the inorganic spacer particle is an inorganic material comprising one or more of barium sulfate, calcium carbonate, silica, kaolin, alkali and alkaline earth metal silicates.

Polymer Resin

The encapsulated cyan pigment can comprise a resin, for example a polymer resin. The polymer resin may comprise a thermoplastic polymer. A thermoplastic polymer is sometimes referred to as a thermoplastic resin. In some examples, the polymer may be selected from ethylene or propylene acrylic acid co-polymers; ethylene or propylene methacrylic acid co-polymers; ethylene vinyl acetate co-polymers; co-polymers of ethylene or propylene (e.g. 80 wt % to 99.9 wt %), and alkyl (e.g. C1 to C5) ester of methacrylic or acrylic acid (e.g. 0.1 wt % to 20 wt %); co-polymers of ethylene (e.g. 80 wt % to 99.9 wt %), acrylic or methacrylic acid (e.g. 0.1 wt % to 20.0 wt %) and alkyl (e.g. C1 to C5) ester of methacrylic or acrylic acid (e.g. 0.1 wt % to 20 wt %); co-polymers of ethylene or propylene (e.g. 70 wt % to 99.9 wt %) and maleic anhydride (e.g. 0.1 wt % to 30 wt %); polyethylene; polystyrene; isotactic polypropylene (crystalline); co-polymers of ethylene ethylene ethyl acrylate; polyesters; polyvinyl toluene; polyamides; styrene/butadiene co-polymers; epoxy resins; acrylic resins (e.g. co-polymer of acrylic or methacrylic acid and at least one alkyl ester of acrylic or methacrylic acid wherein alkyl may have from 1 to about 20 carbon atoms, such as methyl methacrylate (e.g. 50% to 90%)/methacrylic acid (e.g. 0 wt % to 20 wt %)/ethylhexylacrylate (e.g. 10 wt % to 50 wt %)); ethylene-acrylate terpolymers: ethylene-acrylic esters-maleic anhydride (MAH) or glycidyl methacrylate (GMA) terpolymers; ethylene-acrylic acid ionomers and combinations thereof.

The resin may comprise a polymer having acidic side groups. Examples of the polymer having acidic side groups will now be described. The polymer having acidic side groups may have an acidity of 50 mg KOH/g or more, in some examples an acidity of 60 mg KOH/g or more, in some examples an acidity of 70 mg KOH/g or more, in some examples an acidity of 80 mg KOH/g or more, in some examples an acidity of 90 mg KOH/g or more, in some examples an acidity of 100 mg KOH/g or more, in some examples an acidity of 105 mg KOH/g or more, in some examples 110 mg KOH/g or more, in some examples 115 mg KOH/g or more. The polymer having acidic side groups may have an acidity of 200 mg KOH/g or less, in some examples 190 mg or less, in some examples 180 mg or less, in some examples 130 mg KOH/g or less, in some examples 120 mg KOH/g or less. Acidity of a polymer, as measured in mg KOH/g can be measured using standard procedures known in the art, for example using the procedure described in ASTM D1386.

The resin may comprise a polymer, in some examples a polymer having acidic side groups, that has a melt flow rate of less than about 70 g/10 minutes, in some examples about 60 g/10 minutes or less, in some examples about 50 g/10 minutes or less, in some examples about 40 g/10 minutes or less, in some examples 30 g/10 minutes or less, in some examples 20 g/10 minutes or less, in some examples 10 g/10 minutes or less. In some examples, all polymers having acidic side groups and/or ester groups in the particles each individually have a melt flow rate of less than 90 g/10 minutes, 80 g/10 minutes or less, in some examples 80 g/10 minutes or less, in some examples 70 g/10 minutes or less, in some examples 70 g/10 minutes or less, in some examples 60 g/10 minutes or less.

The polymer having acidic side groups can have a melt flow rate of about 10 g/10 minutes to about 120 g/10 minutes, in some examples about 10 g/10 minutes to about 70 g/10 minutes, in some examples about 10 g/10 minutes to 40 g/10 minutes, in some examples 20 g/10 minutes to 30 g/10 minutes. The polymer having acidic side groups can have a melt flow rate of, in some examples, about 50 g/10 minutes to about 120 g/10 minutes, in some examples 60 g/10 minutes to about 100 g/10 minutes. The melt flow rate can be measured using standard procedures known in the art, for example as described in ASTM D1238.

The acidic side groups may be in free acid form or may be in the form of an anion and associated with one or more counterions, typically metal counterions, e.g. a metal selected from the alkali metals, such as lithium, sodium and potassium, alkali earth metals, such as magnesium or calcium, and transition metals, such as zinc. The polymer having acidic sides groups can be selected from resins such as co-polymers of ethylene and an ethylenically unsaturated acid of either acrylic acid or methacrylic acid; and ionomers thereof, such as methacrylic acid and ethylene-acrylic or methacrylic acid co-polymers which are at least partially neutralized with metal ions (e.g. Zn, Na, Li) such as SURLYN® ionomers. The polymer comprising acidic side groups can be a co-polymer of ethylene and an ethylenically unsaturated acid of either acrylic or methacrylic acid, where the ethylenically unsaturated acid of either acrylic or methacrylic acid constitute from 5 wt % to about 25 wt % of the co-polymer, in some examples from 10 wt % to about 20 wt % of the co-polymer.

The resin may comprise two different polymers having acidic side groups. The two polymers having acidic side groups may have different acidities, which may fall within the ranges mentioned above. The resin may comprise a first polymer having acidic side groups that has an acidity of from 10 mg KOH/g to 110 mg KOH/g, in some examples 20 mg KOH/g to 110 mg KOH/g, in some examples 30 mg KOH/g to 110 mg KOH/g, in some examples 50 mg KOH/g to 110 mg KOH/g, and a second polymer having acidic side groups that has an acidity of 110 mg KOH/g to 130 mg KOH/g. The resin may comprise two different polymers having acidic side groups: a first polymer having acidic side groups that has a melt flow rate of about 10 g/10 minutes to about 50 g/10 minutes and an acidity of from 10 mg KOH/g to 110 mg KOH/g, in some examples 20 mg KOH/g to 110 mg KOH/g, in some examples 30 mg KOH/g to 110 mg KOH/g, in some examples 50 mg KOH/g to 110 mg KOH/g, and a second polymer having acidic side groups that has a melt flow rate of about 50 g/10 minutes to about 120 g/10 minutes and an acidity of 110 mg KOH/g to 130 mg KOH/g. The first and second polymers may be absent of ester groups.

The resin may comprise two different polymers having acidic side groups that are selected from copolymers of ethylene and an ethylenically unsaturated acid of either methacrylic acid or acrylic acid; and ionomers thereof, such as methacrylic acid and ethylene-acrylic or methacrylic acid copolymers which are at least partially neutralized with metal ions (e.g. Zn, Na, Li) such as SURLYN® ionomers. The resin may comprise (i) a first polymer that is a copolymer of ethylene and an ethylenically unsaturated acid of either acrylic acid and methacrylic acid, wherein the ethylenically unsaturated acid of either acrylic or methacrylic acid constitutes from 8 wt % to about 16 wt % of the copolymer, in some examples 10 wt % to 16 wt % of the copolymer; and (ii) a second polymer that is a copolymer of ethylene and an ethylenically unsaturated acid of either acrylic acid and methacrylic acid, wherein the ethylenically unsaturated acid of either acrylic or methacrylic acid constitutes from 12 wt % to about 30 wt % of the copolymer, in some examples from 14 wt % to about 20 wt % of the copolymer, in some examples from 16 wt % to about 20 wt % of the copolymer in some examples from 17 wt % to 19 wt % of the copolymer.

The resin may comprise two different polymers having acidic side groups: a first polymer that is a copolymer of ethylene (e.g. 92 to 85 wt %, in some examples about 89 wt %) and acrylic or methacrylic acid (e.g. 8 to 15 wt %, in some examples about 11 wt %) having a melt flow rate of 80 to 110 g/10 minutes and a second polymer that is a co-polymer of ethylene (e.g. about 80 to 92 wt %, in some examples about 85 wt %) and acrylic acid (e.g. about 18 to 12 wt %, in some examples about 15 wt %), having a melt viscosity lower than that of the first polymer, the second polymer for example having a melt viscosity of 15000 poise or less, in some examples a melt viscosity of 10000 poise or less, in some examples 1000 poise or less, in some examples 100 poise or less, in some examples 50 poise or less, in some examples 10 poise or less. Melt viscosity can be measured using standard techniques. The melt viscosity can be measured using a rheometer, e.g. a commercially available AR-2000 Rheometer from Thermal Analysis Instruments, using the geometry of: 25 mm steel plate-standard steel parallel plate, and finding the plate over plate rheometry isotherm at 120° C., 0.01 hz shear rate.

In any of the examples mentioned above, the ratio of the first polymer having acidic side groups to the second polymer having acidic side groups can be from about 10:1 to about 2:1. In another example, the ratio can be from about 6:1 to about 3:1, in some examples about 4:1.

The resin may comprise a polymer having a melt viscosity of 15000 poise or less, in some examples a melt viscosity of 10000 poise or less, in some examples 1000 poise or less, in some examples 100 poise or less, in some examples 50 poise or less, in some examples 10 poise or less; said polymer may be a polymer having acidic side groups as described herein. The resin may comprise a first polymer having a melt viscosity of 15000 poise or more, in some examples 20000 poise or more, in some examples 50000 poise or more, in some examples 70000 poise or more; and in some examples, the resin may comprise a second polymer having a melt viscosity less than the first polymer, in some examples a melt viscosity of 15000 poise or less, in some examples a melt viscosity of 10000 poise or less, in some examples 1000 poise or less, in some examples 100 poise or less, in some examples 50 poise or less, in some examples 10 poise or less. The resin may comprise a first polymer having a melt viscosity of more than 60000 poise, in some examples from 60000 poise to 100000 poise, in some examples from 65000 poise to 85000 poise; a second polymer having a melt viscosity of from 15000 poise to 40000 poise, in some examples 20000 poise to 30000 poise, and a third polymer having a melt viscosity of 15000 poise or less, in some examples a melt viscosity of 10000 poise or less, in some examples 1000 poise or less, in some examples 100 poise or less, in some examples 50 poise or less, in some examples 10 poise or less; an example of the first polymer is Nucrel 960 (from DuPont), and example of the second polymer is Nucrel 699 (from DuPont), and an example of the third polymer is AC-5120 or AC-5180 (from Honeywell). The first, second and third polymers may be polymers having acidic side groups as described herein. The melt viscosity can be measured using a rheometer, e.g. a commercially available AR-2000 Rheometer from Thermal Analysis Instruments, using the geometry of: 25 mm steel plate-standard steel parallel plate, and finding the plate over plate rheometry isotherm at 120° C., 0.01 Hz shear rate.

If the resin comprises a single type of polymer, the polymer (excluding any other components of the electrophotographic ink composition) may have a melt viscosity of 6000 poise or more, in some examples a melt viscosity of 8000 poise or more, in some examples a melt viscosity of 10000 poise or more, in some examples a melt viscosity of 12000 poise or more. If the resin comprises a plurality of polymers all the polymers of the resin may together form a mixture (excluding any other components of the electrophotographic ink composition) that has a melt viscosity of 6000 poise or more, in some examples a melt viscosity of 8000 poise or more, in some examples a melt viscosity of 10000 poise or more, in some examples a melt viscosity of 12000 poise or more. Melt viscosity can be measured using standard techniques. The melt viscosity can be measured using a rheometer, e.g. a commercially available AR-2000 Rheometer from Thermal Analysis Instruments, using the geometry of: 25 mm steel plate-standard steel parallel plate, and finding the plate over plate rheometry isotherm at 120° C., 0.01 Hz shear rate.

If the resin comprises a single type of resin polymer, the resin polymer (excluding any other components of the electrostatic ink composition) may have a melt viscosity of 6000 poise or more, in some examples a melt viscosity of 8000 poise or more, in some examples a melt viscosity of 10000 poise or more, in some examples a melt viscosity of 12000 poise or more. If the resin comprises a plurality of polymers all the polymers of the resin may together form a mixture (excluding any other components of the electrostatic ink composition) that has a melt viscosity of 6000 poise or more, in some examples a melt viscosity of 8000 poise or more, in some examples a melt viscosity of 10000 poise or more, in some examples a melt viscosity of 12000 poise or more. Melt viscosity can be measured using standard techniques. The melt viscosity can be measured using a rheometer, e.g. a commercially available AR-2000 Rheometer from Thermal Analysis Instruments, using the geometry of: 25 mm steel plate-standard steel parallel plate, and finding the plate over plate rheometry isotherm at 120° C., 0.01 hz shear rate.

The resin may comprise a polymer having acidic side groups, as described above (which may be free of ester side groups), and a polymer having ester side groups. The polymer having ester side groups may be a thermoplastic polymer. The polymer having ester side groups may further comprise acidic side groups. The polymer having ester side groups may be a co-polymer of a monomer having ester side groups and a monomer having acidic side groups. The polymer may be a co-polymer of a monomer having ester side groups, a monomer having acidic side groups, and a monomer absent of any acidic and ester side groups. The monomer having ester side groups may be a monomer selected from esterified acrylic acid or esterified methacrylic acid. The monomer having acidic side groups may be a monomer selected from acrylic or methacrylic acid. The monomer absent of any acidic and ester side groups may be an alkylene monomer, including, but not limited to, ethylene or propylene. The esterified acrylic acid or esterified methacrylic acid may, respectively, be an alkyl ester of acrylic acid or an alkyl ester of methacrylic acid. The alkyl group in the alkyl ester of acrylic or methacrylic acid may be an alkyl group having 1 to 30 carbons, in some examples 1 to 20 carbons, in some examples 1 to 10 carbons; in some examples selected from methyl, ethyl, iso-propyl, n-propyl, t-butyl, iso-butyl, n-butyl and pentyl.

The polymer having ester side groups may be a co-polymer of a first monomer having ester side groups, a second monomer having acidic side groups and a third monomer which is an alkylene monomer absent of any acidic and ester side groups. The polymer having ester side groups may be a co-polymer of (i) a first monomer having ester side groups selected from esterified acrylic acid or esterified methacrylic acid, in some examples an alkyl ester of acrylic or methacrylic acid, (ii) a second monomer having acidic side groups selected from acrylic or methacrylic acid and (iii) a third monomer which is an alkylene monomer selected from ethylene and propylene. The first monomer may constitute 1% to 50% by weight of the co-polymer, in some examples 5% to 40% by weight, in some examples 5% to 20% by weight of the co-polymer, in some examples 5% to 15% by weight of the co-polymer. The second monomer may constitute 1% to 50% by weight of the co-polymer, in some examples 5% to 40% by weight of the co-polymer, in some examples 5% to 20% by weight of the co-polymer, in some examples 5% to 15% by weight of the co-polymer. The first monomer can constitute 5% to 40% by weight of the co-polymer, the second monomer constitutes 5% to 40% by weight of the co-polymer, and with the third monomer constituting the remaining weight of the co-polymer. In some examples, the first monomer constitutes 5% to 15% by weight of the co-polymer, the second monomer constitutes 5% to 15% by weight of the co-polymer, with the third monomer constituting the remaining weight of the co-polymer. In some examples, the first monomer constitutes 8% to 12% by weight of the co-polymer, the second monomer constitutes 8% to 12% by weight of the co-polymer, with the third monomer constituting the remaining weight of the co-polymer. In some examples, the first monomer constitutes about 10% by weight of the co-polymer, the second monomer constitutes about 10% by weight of the co-polymer, and with the third monomer constituting the remaining weight of the co-polymer. The polymer may be selected from the Bynel® class of monomer, including Bynel 2022 and Bynel 2002, which are available from DuPont®.

The polymer having ester side groups may constitute 1% or more by weight of the total amount of the resin polymers in the resin, e.g. the total amount of the polymer or polymers having acidic side groups and polymer having ester side groups. The polymer having ester side groups may constitute 5% or more by weight of the total amount of the resin polymers in the resin, in some examples 8% or more by weight of the total amount of the resin polymers in the resin, in some examples 10% or more by weight of the total amount of the resin polymers in the resin, in some examples 15% or more by weight of the total amount of the resin polymers in the resin, in some examples 20% or more by weight of the total amount of the resin polymers in the resin, in some examples 25% or more by weight of the total amount of the resin polymers in the resin, in some examples 30% or more by weight of the total amount of the resin polymers in the resin, in some examples 35% or more by weight of the total amount of the resin polymers in the resin. The polymer having ester side groups may constitute from 5% to 50% by weight of the total amount of the resin polymers in the resin, in some examples 10% to 40% by weight of the total amount of the resin polymers in the resin, in some examples 15% to 30% by weight of the total amount of the polymers in the resin.

The polymer having ester side groups may have an acidity of 50 mg KOH/g or more, in some examples an acidity of 60 mg KOH/g or more, in some examples an acidity of 70 mg KOH/g or more, in some examples an acidity of 80 mg KOH/g or more. The polymer having ester side groups may have an acidity of 100 mg KOH/g or less, in some examples 90 mg KOH/g or less. The polymer having ester side groups may have an acidity of 60 mg KOH/g to 90 mg KOH/g, in some examples 70 mg KOH/g to 80 mg KOH/g.

The polymer having ester side groups may have a melt flow rate of about 10 g/10 minutes to about 120 g/10 minutes, in some examples about 10 g/10 minutes to about 50 g/10 minutes, in some examples about 20 g/10 minutes to about 40 g/10 minutes, in some examples about 25 g/10 minutes to about 35 g/10 minutes.

The polymer, polymers, co-polymer or co-polymers of the resin can in some examples be selected from the Nucrel family of toners (e.g. Nucrel 403™, Nucrel 407™, Nucrel 609HS™, Nucrel 908HS™, Nucrel 1202HC™, Nucrel 30707™, Nucrel 1214™, Nucrel 903™, Nucrel 3990™, Nucrel 910™, Nucrel 925™, Nucrel 699™, Nucrel 599TH, Nucrel 960™, Nucrel RX 76™, Nucrel 2806™, Bynell 2002, Bynell 2014, Bynell 2020 and Bynell 2022, (sold by E. I. du PONT)), the AC family of toners (e.g. AC-5120, AC-5180, AC-540, AC-580 (sold by Honeywell)), the Aclyn family of toners (e.g. Aclyn 201, Aclyn 246, Aclyn 285, and Aclyn 295), and the Lotader family of toners (e.g. Lotader 2210, Lotader, 3430, and Lotader 8200 (sold by Arkema)).

In an example, the resin constitutes about 5 to 90%, in some examples about 5 to 70%, by weight of any of: (i) the solids of the electrostatic ink composition, (ii) the solids of the second portion of the carrier liquid; (iii) the solids of the carrier liquid before precipitation of the resin, (iv) the solids of the composition resulting from the method, which may be an electrostatic ink composition. In another example, the resin constitutes about 10 to 60% by weight of any of (i) the solids of the electrostatic ink composition, (ii) the solids of the second portion of the carrier liquid; (iii) the solids of the carrier liquid before precipitation of the resin, (iv) the solids of the composition resulting from the method, which may be an electrostatic ink composition. In another example, the resin constitutes about 15 to 40% by weight of any of: (i) the solids of the electrostatic ink composition, (ii) the solids of the second portion of the carrier liquid; (iii) the solids of the carrier liquid before precipitation of the resin, (iv) the solids of the composition resulting from the method, which may be an electrostatic ink composition. In another example, the resin constitutes about 60 to 95% by weight, in some examples from 70 to 90% by weight, in some examples 75 to 85% by weight, of any of: (i) the solids of the electrostatic ink composition, (ii) the solids of the second portion of the carrier liquid; (iii) the solids of the carrier liquid before precipitation of the resin, (iv) the solids of the composition resulting from the method, which may be an electrostatic ink composition.

Carrier Fluid

In some examples, the methods described produce coated pigment particles which are formed in and/or dispersed in a carrier fluid or carrier liquid. Before application to the print substrate in the electrostatic printing process, the composition may be an electrostatic ink composition, which may be in dry form, for example in the form of flowable pigment particles coated with the thermoplastic resin. Alternatively, before application to the print substrate in the electrostatic printing process, the electrostatic ink composition may be in liquid form; and may comprise a carrier liquid in which is suspended cyan pigment particles coated with the thermoplastic resin.

Generally, the carrier liquid acts as a reaction solvent in preparing the coated pigment particles, and can also act as a dispersing medium for the other components in the resulting electrostatic ink composition. In one example, the carrier liquid is a liquid which does not dissolve the polymer resin at room temperature. In one example, the carrier liquid is a liquid which dissolves the polymer resin at elevated temperatures. For example, the polymer resin may be soluble in the carrier liquid when heated to a temperature of at least 80° C., for example 90° C., for example 100° C., for example 110° C., for example 120° C. For example, the carrier liquid can comprise or be a hydrocarbon, silicone oil, vegetable oil, etc. The carrier liquid can include, but is not limited to, an insulating, non-polar, non-aqueous liquid that can be used as a medium for toner particles. The carrier liquid can include compounds that have a resistivity in excess of about 10⁹ ohm-cm. The carrier liquid may have a dielectric constant below about 5, in some examples below about 3. The carrier liquid can include, but is not limited to, hydrocarbons. The hydrocarbon can include, but is not limited to, an aliphatic hydrocarbon, an isomerized aliphatic hydrocarbon, branched chain aliphatic hydrocarbons, aromatic hydrocarbons, and combinations thereof. Examples of the carrier liquids include, but are not limited to, aliphatic hydrocarbons, isoparaffinic compounds, paraffinic compounds, dearomatized hydrocarbon compounds, and the like. In particular, the carrier liquids can include, but are not limited to, Isopar-G™, Isopar-H™, Isopar-L™, Isopar-M™, Isopar-K™, Isopar-V™, Norpar12™, Norpar 13™, Norpar15™, Exxol D40™, Exxol D80™, Exxol D100™, Exxol D130™, and Exxol D140™ (each sold by EXXON CORPORATION); Teclen N-16™, Teclen N-20™, Teclen N-22™, Nisseki Naphthesol L™, Nisseki Naphthesol M™, Nisseki Naphthesol H™, #0 Solvent L™, #0 Solvent M™, #0 Solvent H™, Nisseki Isosol 300™, Nisseki Isosol 400™, AF-4™, AF-5™, AF-6™ and AF-7™ (each sold by NIPPON OIL CORPORATION); IP Solvent 1620™and IP Solvent 2028™(each sold by IDEMITSU PETROCHEMICAL CO., LTD.); Amsco OMS™ and Amsco 460™(each sold by AMERICAN MINERAL SPIRITS CORP.); and Electron, Positron, New II, Purogen HF (100% synthetic terpenes) (sold by ECOLINK™).

In the example in which the carrier liquid is acting as a solvent during preparation of the liquid electrophotographic ink composition comprising coated cyan pigment particles, the carrier liquid can constitute about 20% to 99.5% by weight of the composition, in some examples 50% to 99.5% by weight of the composition in the step of coating the particles. In the example in which the carrier liquid is acting as a solvent during preparation of coated pigment particles, the carrier liquid may constitute about 40 to 90% by weight of the composition in the step of coating the particles. In the example in which the carrier liquid is acting as a solvent during preparation of coated pigment particles, the carrier liquid may constitute about 60% to 80% by weight of the composition in the step of coating the particles. In the example in which the carrier liquid is acting as a solvent during preparation of coated pigment particles, the carrier liquid may constitute about 90% to 99.5% by weight of the composition, in some examples 95% to 99% by weight of the composition in the step of coating the particles.

Before printing, the carrier liquid can constitute about 20% to 99.5% by weight of the electrostatic ink composition, in some examples 50% to 99.5% by weight of the electrostatic ink composition. Before printing, the carrier liquid may constitute about 40 to 90% by weight of the electrostatic ink composition. Before printing, the carrier liquid may constitute about 60% to 80% by weight of the electrostatic ink composition. Before printing, the carrier liquid may constitute about 90% to 99.5% by weight of the electrostatic ink composition, in some examples 95% to 99% by weight of the electrostatic ink composition.

The ink, when printed on the print substrate, may be substantially free from carrier liquid. In an electrostatic printing process and/or afterwards, the carrier liquid may be removed, e.g. by an electrophoresis process during printing and/or evaporation, such that substantially just solids are transferred to the print substrate. Substantially free from carrier liquid may indicate that the ink printed on the print substrate contains less than 5 wt % carrier liquid, in some examples, less than 2 wt % carrier liquid, in some examples less than 1 wt % carrier liquid, in some examples less than 0.5 wt % carrier liquid. In some examples, the ink printed on the print substrate is free from carrier liquid.

Charge Director

The liquid electrophotographic composition and/or the ink composition printed on the print substrate can comprise a charge director. The method as described here may involve adding a charge director at any stage. A charge director can be added to an electrostatic composition to impart a charge of a desired polarity and/or maintain sufficient electrostatic charge on the particles of an electrostatic ink composition. The charge director may comprise ionic compounds, including, but not limited to, metal salts of fatty acids, metal salts of sulfo-succinates, metal salts of oxyphosphates, metal salts of alkyl-benzenesulfonic acid, metal salts of aromatic carboxylic acids or sulfonic acids, as well as zwitterionic and non-ionic compounds, such as polyoxyethylated alkylamines, lecithin, polyvinylpyrrolidone, organic acid esters of polyvalent alcohols, etc. The charge director can be selected from, but is not limited to, oil-soluble petroleum sulfonates (e.g. neutral Calcium Petronate™, neutral Barium Petronate™ and basic Barium Petronate™), polybutylene succinimides (e.g. OLOA™ 1200 and Amoco 575), and glyceride salts (e.g. sodium salts of phosphated mono- and diglycerides with unsaturated and saturated acid substituents), sulfonic acid salts including, but not limited to, barium, sodium, calcium, and aluminium salts of sulfonic acid. The sulfonic acids may include, but are not limited to, alkyl sulfonic acids, aryl sulfonic acids, and sulfonic acids of alkyl succinates (e.g. see WO 2007/130069). The charge director can impart a negative charge or a positive charge on the resin-coated cyan pigment particles of an electrostatic ink composition.

The charge director can comprise a sulfosuccinate moiety of the general formula [Rₐ—O—C(O)CH₂CH(SO₃)C(O)—O—R_{b}], where each of Rₐ and R_{b} is an alkyl group. In some examples, the charge director comprises nanoparticles of a simple salt and a sulfosuccinate salt of the general formula MAₙ, wherein M is a metal, n is the valence of M, and A is an ion of the general formula [Rₐ—O—C(O)CH₂CH(SO₃)C(O)—O—R_{b}], where each of Rₐ and R_{b} is an alkyl group, or other charge directors as found in WO2007130069, which is incorporation herein by reference in its entirety. As described in WO2007130069, the sulfosuccinate salt of the general formula MA, is an example of a micelle forming salt. The charge director may be substantially free or free of an acid of the general formula HA, where A is as described above. The charge director may comprise micelles of said sulfosuccinate salt enclosing at least some of the nanoparticles. The charge director may comprise at least some nanoparticles having a size of 200 nm or less, in some examples 2 nm or more. As described in WO2007130069, simple salts are salts that do not form micelles by themselves, although they may form a core for micelles with a micelle forming salt. The ions constructing the simple salts are all hydrophilic. The simple salt may comprise a cation selected from Mg, Ca, Ba, NH₄, tert-butyl ammonium, Li⁺, and Al⁺³, or from any sub-group thereof. The simple salt may comprise an anion selected from SO₄²⁻, PO³⁻, NO₃⁻, HPO₄²⁻, CO₃²⁻, acetate, trifluoroacetate (TFA), Cr, Bf, F, ClO₄⁻, and TiO₃⁴⁻, or from any sub-group thereof. The simple salt may be selected from CaCO₃, Ba₂TiO₃, Al₂(SO₄), A1(NO₃)₃, Ca₃(PO₄)₂, BaSO₄, BaHPO₄, Ba₂(PO₄)₃, CaSO₄, (NH₄)₂CO₃, (NH₄)₂SO₄, NH₄OAc, Tert-butyl ammonium bromide, NH₄NO₃, LiTFA, Al₂(SO₄)₃, LiClO₄ and LiBF₄, or any sub-group thereof. The charge director may further comprise basic barium petronate (BBP).

In the formula [Rₐ—O—C(O)CH₂CH(SO₃⁻)C(O)—O—R_{b}], in some examples, each of Rₐ and R_{b} is an aliphatic alkyl group. In some examples, each of Rₐ and R_{b} independently is a C₆₋₂₅ alkyl. In some examples, said aliphatic alkyl group is linear. In some examples, said aliphatic alkyl group is branched. In some examples, said aliphatic alkyl group includes a linear chain of more than 6 carbon atoms. In some examples, Rₐ and R_{b} are the same. In some examples, at least one of Rₐ and R_{b} is C₁₃H₂₇. In some examples, M is Na, K, Cs, Ca, or Ba. The formula [Rₐ—O—C(O)CH₂CH(SO₃⁻)C(O)—O—R_{b}] and/or the formula MAₙ may be as defined in any part of WO2007130069.

The charge director may comprise (i) soya lecithin, (ii) a barium sulfonate salt, such as basic barium petronate (BPP), and (iii) an isopropyl amine sulfonate salt. Basic barium petronate is a barium sulfonate salt of a 21-26 hydrocarbon alkyl, and can be obtained, for example, from Chemtura. An example isopropyl amine sulphonate salt is dodecyl benzene sulfonic acid isopropyl amine, which is available from Croda.

In some examples, the charge director constitutes about 0.001% to 20%, in some examples 0.01 to 20% by weight, in some examples 0.01 to 10% by weight, in some examples 0.01 to 1% by weight of any of: (i) the solids of the electrostatic ink composition, (ii) the solids of the second portion of the carrier liquid; (iii) the solids of the carrier liquid before precipitation of the resin, (iv) the solids of the composition resulting from the method, which may be an electrostatic ink composition. In some examples, the charge director constitutes about 0.001 to 0.15% by weight of any of: (i) the solids of the electrostatic ink composition, (ii) the solids of the second portion of the carrier liquid; (iii) the solids of the carrier liquid before precipitation of the resin, (iv) the solids of the composition resulting from the method, which may be an electrostatic ink composition, in some examples 0.001 to 0.15%, in some examples 0.001 to 0.02% by weight of any of: (i) the solids of the electrostatic ink composition, (ii) the solids of the second portion of the carrier liquid; (iii) the solids of the carrier liquid before precipitation of the resin, (iv) the solids of the composition resulting from the method, which may be an electrostatic ink composition.

Charge Adjuvant

The liquid electrophotographic ink composition and/or ink composition printed on the print substrate can include a charge adjuvant. A charge adjuvant may be present with a charge director, and may be different to the charge director, and act to increase and/or stabilise the charge on particles, e.g. resin-containing particles, of an electrostatic composition. The charge adjuvant can include, but is not limited to, barium petronate, calcium petronate, Co salts of naphthenic acid, Ca salts of naphthenic acid, Cu salts of naphthenic acid, Mn salts of naphthenic acid, Ni salts of naphthenic acid, Zn salts of naphthenic acid, Fe salts of naphthenic acid, Ba salts of stearic acid, Co salts of stearic acid, Pb salts of stearic acid, Zn salts of stearic acid, Al salts of stearic acid, Cu salts of stearic acid, Fe salts of stearic acid, metal carboxylates (e.g. Al tristearate, Al octanoate, Li heptanoate, Fe stearate, Fe distearate, Ba stearate, Cr stearate, Mg octanoate, Ca stearate, Fe naphthenate, Zn naphthenate, Mn heptanoate, Zn heptanoate, Ba octanoate, Al octanoate, Co octanoate, Mn octanoate, and Zn octanoate), Co lineolates, Mn lineolates, Pb lineolates, Zn lineolates, Ca oleates, Co oleates, Zn palmirate, Ca resinates, Co resinates, Mn resinates, Pb resinates, Zn resinates, AB diblock co-polymers of 2-ethylhexyl methacrylate-co-methacrylic acid calcium, and ammonium salts, co-polymers of an alkyl acrylamidoglycolate alkyl ether (e.g. methyl acrylamidoglycolate methyl ether-co-vinyl acetate), and hydroxy bis(3,5-di-tert-butyl salicylic) aluminate monohydrate. In some examples, the charge adjuvant is aluminium di and/or tristearate and/or aluminium di and/or tripalmitate.

The charge adjuvant may be present in an amount of about 0.1 to 5, about 0.5 to 4, and about 1 to 3% weight in any of: (i) the solids of the electrostatic ink composition, (ii) the solids of the second portion of the carrier liquid; (iii) the solids of the carrier liquid before precipitation of the resin, (iv) the solids of the composition resulting from the method, which may be an electrostatic ink composition.

Other Additives

The electrophotographic ink composition may include an additive or a plurality of additives. The additive or plurality of additives may be added at any stage of the method. The additive or plurality of additives may be selected from a wax, a surfactant, biocides, organic solvents, viscosity modifiers, materials for pH adjustment, sequestering agents, preservatives, compatibility additives, emulsifiers and the like. The wax may be an incompatible wax. As used herein, “incompatible wax” may refer to a wax that is incompatible with the resin. Specifically, the wax phase separates from the resin phase upon the cooling of the resin fused mixture on a print substrate during and after the transfer of the ink film to the print substrate, e.g. from an intermediate transfer member, which may be a heated blanket.

In some examples a surfactant is present in the any portion of the carrier fluid before, during and/or after effecting precipitation of the resin. In some examples a surfactant is present in the electrostatic ink composition or the composition resulting from the method, which may be an electrostatic ink composition. A surfactant has been found to promote encapsulation of the cyan pigment particles by the resin, which has been found to promote the print properties of resin-coated metallic pigment particles. Surfactants comprises an acidic group have been found to be particularly effective. Accordingly, in some examples, the surfactant comprises an acidic group. In some examples, the surfactant is or comprises a polyhydroxy fatty acid, which may be a saturated or unsaturated fatty acid. The polyhydroxy fatty acid may be a C₈ to C₂₆ polyhydroxy fatty acid, in some examples a C₁₂ to C₂₀ polyhydroxy fatty acid, in some examples a C₁₆ to C₂₀ polyhydroxy fatty acid. In some examples, the polyhydroxy fatty acid is a polyhydroxystearic acid. In some examples, the polyhydroxy fatty acid is poly(12-hydroxystearic acid) stearate. In some examples, the surfactant is or comprises Solsperse® 3000, available from Lubrizol. The polyhydroxy fatty acid may have a molecular weight of at least 300 Daltons, in some examples at least 1000 Daltons, in some examples 300 to 24000 Daltons, in some examples 1000 to 24000 Daltons.

In some examples, the surfactant may be selected from anionic surfactant, cationic surfactant, amphoteric surfactant, non-ionic surfactant, polymeric surfactant, oligomeric surfactant, crosslinking surfactant, or combinations thereof.

The anionic surfactant may be or comprise sulfosuccinic acid and derivatives thereof such as, for instance, alkyl sulfosuccinates (e.g., GEROPON® SBFA-30 and GEROPON® SSO-75, both of which are manufactured by Rhodia, Boulogne-Billancourt, France) and docusate sodium.

The cationic surfactant may be selected from quaternary amine polymers, protonated amine polymers, and polymers containing aluminum (such as those that are available from Lubrizol Corp., Wickliffe, Ohio). Further examples of cationic surfacants include SOLSPERSE® 2155, 9000, 13650, 13940, and 19000 (Lubrizol Corp.) and other like cationic surfacants.

The amphoteric surfactant may be selected from surfactants that contain compounds having protonizable groups and/or ionizable acid groups. An example of a suitable amphoteric surfacant includes lecithin.

The non-ionic surfactant may be selected from oil-soluble polyesters, polyamines, polyacrylates, polymethacrylates (such as, e.g., SOLSPERSE® 3000 (Lubrizol Corp.), SOLSPERSE® 21000 (Lubrizol Corp.), or the like.

The oligomeric surfactant may be selected from low average molecular weight (i.e, less than 1000) non-ionic surfactants.

The cross-linking surfactant may be selected from polymers or oligomers containing two or more carbon double bonds (C═C) and/or free amine groups such as, e.g., polyamines, crosslinkable polyurethanes, and divinyl benzene.

Other suitable surfacants include OS #13309AP, OS #13309AQ, 14179BL, and 45479AB from Lubrizol Corp, which are surfacants based on polyisobutylene succinic acid with polyethyleneimines. These surfacants are combination polymers that are cationic in nature.

In some examples, the surfactant is selected from a fatty acid sarcosine and a fatty acid sarcosinate. In some examples, the fatty acid in the fatty acid sarcosine and/or fatty acid sarcosinate is selected from a C₈ to C₂₆ fatty acid, in some examples a C₁₂ to C₂₀ fatty acid, in some examples a C₁₆ to C₂₀ fatty acid. The fatty acid may be saturated or unsaturated. In some examples, the fatty acid in the fatty acid sarcosine and/or fatty acid sarcosinate is selected from lauroyl, cocoyl, myristoyl, oleoyl, and stearoyl. Suitable surfactants may be available from Crodasinic®, for example Crodasinic L, C, M, O, S or SM.

Surfactants typically comprise a head group and a tail group, with the head group and tail group typically of different polarity, e.g. the head group being polar and the tail group being relatively non-polar compared to the head group. The surfactant may comprise an acidic head group, e.g. a head group comprising a carboxylic acid. The surfactant may comprise a basic head group. The basic head group may comprise an amine group, which may be selected from a primary amine group and a secondary amine group. The basic head group may comprise a plurality of amine groups, which may each independently be selected from a primary amine group and a secondary amine group.

In some examples, the surfactant comprises a succinimide. The succinimide may be linked, e.g. via a hydrocarbon-containing linker group, to an amine group. In some examples, the surfactant comprises a polyisobutylene succinimide having a head group comprising an amine.

In some examples, the surfactant is of formula (I)

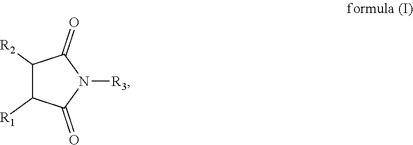

wherein R₁, R₂ and R₃ are selected from an amine-containing head group, a hydrocarbon tail group and hydrogen,

wherein at least one of R₁, R₂ and R₃ comprises a hydrocarbon tail group, at least one of R₁, R₂ and R₃ comprises an amine-containing head group. In some examples, R₁ and R₂ are selected from a hydrocarbon tail group and hydrogen, with at least one of R₁ and R₂ comprising a hydrocarbon tail group, and R₃ comprises an amine-containing head group. The hydrocarbon tail group may comprise or be a hydrocarbon group, which may be branched or straight chain and may be unsubstituted. The hydrocarbon tail group may comprise or be a hydrocarbon group containing a polyalkylene, which may be selected from a polyethylene, polypropylene, polybutylene. In some examples, the hydrocarbon tail group may contain a polyisobutylene. The hydrocarbon tail group may contain from 10 to 100 carbons, in some examples from 10 to 50 carbons, in some examples from 10 to 30 carbons. The hydrocarbon tail group may be of the formula (II)

P-L- formula (II),

wherein P is or comprises polyisobutylene and L is selected from a single bond, (CH₂)ₙ, wherein n is from 0 to 5, in some examples 1 to 5, —O— and —NH—. In some examples, the amine-containing head group comprises or is a hydrocarbon group having an amine group attached to one of the carbons of the hydrocarbon group. In some examples, the amine-containing head group is of the formula (III)

(CH₂)ₘ[(CH₂)ₒNH(CH₂)ₚ]_{q}(CH₂)ᵣ−NH₂ formula (III), wherein m is at least 1, in some examples 1 to 5, q is 0 to 10, o is 0, 1 or 2, p is 1 or 2, r is 0 to 10; in some examples, m is 1, o is 1, p is 1 and q is from 0 to 10, in some examples from 1 to 5, and in some examples r is 1 to 5; in some examples m is 1, q is 0 to 10, in some examples 1 to 10, in some examples 1 to 5, o is 1, p is 1, r is 1.

In some examples, the surfactant is of formula (I), wherein R₁ is of formula (II), R₂ is H and R₃ is of formula (III). In some examples, the surfactant is of formula (I), wherein R₁ is of formula (II), wherein L is —CH₂—, R₂ is H and R₃ is of formula (III), wherein m is 1, q is 0 to 10, in some examples 1 to 10, in some examples 1 to 5, o is 1, p is 1 and r is 1. In some examples, the surfactant is or comprises Lubrizol 6406.

Method of Producing the Liquid Electrophotographic Ink Composition

In some examples, the method of producing a liquid electrophotographic ink composition involves dispersing cyan pigment particles to be coated in a first portion of a carrier fluid with the inorganic spacer particles.

In some examples, the cyan pigment particles and inorganic spacer particles are dispersed in the first portion of the carrier liquid at room temperature. In some examples, the cyan pigment particles and inorganic spacer particles are dispersed in the first portion of the carrier liquid with heating, for example to a temperature of at least 35° C., for example to a temperature of at least 45° C., for example to a temperature of at least 55° C., for example to a temperature of at least 65° C., for example to a temperature of at least 75° C.

In some examples, the cyan pigment particles and inorganic spacer particles are dispersed in the first portion of the carrier liquid with high shear mixing. The high shear process may involve stirring the mixture, for example at a high speed, for example a speed of at least 1000 RPM, in some examples at least 2000 RPM, in some examples at least 5000 RPM. The stirring may be carried out for a period of at least 5 minutes, in some examples at least 10 minutes, in some examples at least 20 minutes, in some examples at least 30 minutes, in some examples at least 40 minutes, in some examples at least 50 minutes, in some examples at least 60 minutes. In some examples, the stirring may be carried out at room temperature at at least 5,000 RPM for at least 45 minutes, in some examples at least 5,000 RPM for at least 60 minutes. In some examples, the method of producing a liquid electrophotographic ink composition involves heating a polymer resin in a second portion of a carrier fluid to dissolve the polymer resin.

In some examples, the first and second portions of the carrier liquid are identical in nature. In some examples, the carrier liquid, the first portion thereof and the second portion thereof all comprise or consist of an isoparaffinic carrier liquid. In some examples, the first and second portions of the carrier liquid are different solvents, but are miscible with one another and are both suitable carrier liquids for electrostatic printing.

In some examples, the polymer resin is insoluble in the carrier fluid at room temperature but soluble in the carrier fluid at elevated temperatures, for example at a temperature of at least 50° C., for example at a temperature of at least 60° C., for example at a temperature of at least 70° C., for example at a temperature of at least 80° C., for example at a temperature of at least 90° C., for example at a temperature of at least 100° C., for example at a temperature of at least 110° C., for example at a temperature of at least 120° C. The dispersion of the polymer resin in the second portion of carrier fluid may be heated to any of the above stated temperatures for sufficient time until the polymer resin has dissolved. Dissolution may be confirmed by the carrier fluid appearing clear and homogenous. In some examples, the dispersion of polymer resin in the second portion of carrier fluid may be mixed at a rate of less than 500 rpm, for example less than 400 rpm, for example less than 300 rpm, for example less than 200 rpm until dissolution is complete. In some examples, heating a dispersion of polymer resin in carrier fluid causes the polymer resin to swell with carrier fluid. In some examples, the dispersion of polymer resin in the second portion of carrier fluid is heated to swell the polymer resin. Swelling of the polymer resin allows better encapsulation of the cyan pigment particle. In some examples, the polymer resin is heated in a solvating carrier liquid to swell and solvate the polymer resin. The swollen and solvated polymer resin may then be removed from the solvating carrier liquid and redispersed in a new portion of carrier fluid.

In some examples, the dispersion of cyan pigment particles to be coated is added to the second portion of carrier fluid comprising the dispersed, dissolved or solvated polymer resin. In some examples, the dispersion of cyan pigment particles to be coated is added to the second portion of carrier fluid as a single addition. In some examples, the dispersion of cyan pigment particles is added to the second portion of carrier fluid in a portion-wise manner, over a period of time. In some examples, the dispersion of cyan pigment particles is added to the second portion of carrier fluid over a period of at least 10 minutes, for example at least 20 minutes, for example at least 30 minutes.

In some examples, the dispersion of cyan pigment particles is added to the second portion of carrier fluid after it has been heated and the polymer resin has dissolved. In some examples, the dispersion of cyan pigment particles to be coated is added to the second portion of carrier fluid before any cooling occurs, for example at the temperature at which dissolution of the polymer resin in the carrier fluid was carried out. In some examples, the second portion of carrier fluid may be cooled to an intermediate temperature before the dispersion of pigment particles is added to the carrier fluid. The intermediate temperature may be any temperature above the cloud point of the solution comprising the carrier fluid and the dissolved polymer resin.

The cloud point of any given carrier fluid-polymer resin system can be readily determined by heating and slowly cooling the solution and is the temperature at which dissolved solids begin to precipitate, giving a phase separation and a cloudy or turbid appearance. In some examples, the solution comprising the carrier fluid and the dissolved polymer resin is cooled to at least 2° C., for example at least 3° C., for example at least 4° C., for example at least 5° C., for example at least 6° C., for example at least 7° C., for example at least 8° C., for example at least 9° C., for example at least 10° C. above its cloud point before the pigment particle dispersion is added to the second portion of the carrier fluid.

In some examples, the dispersion of cyan pigment particles is added to the second portion of carrier liquid with high shear mixing. The high shear process may involve stirring the mixture, for example at a high speed, for example a speed of at least 1000 RPM, in some examples at least 2000 RPM, in some examples at least 5000 RPM, in some examples at least 10,000 RPM, in some examples at least 15,000 RPM, in some examples at least 20,000 RPM. The stirring may be carried out for a period of at least 30 seconds, in some examples at least 1 minute, in some examples at least 2 minutes. In some examples, the stirring may be carried out at at least 5,000 RPM for at least 2 minutes, in some examples at 10,000 RPM for at least 2 minutes.

In some examples, the dispersion of pigment particles is mixed into the second portion of carrier fluid at a speed of 12 000 RPM or less, for example 11 000 RPM or less, for example 10 000 RPM or less, for example 9000 RPM or less to ensure complete dispersion before the precipitation of the polymer resin is effected. In other examples, the dispersion of pigment particles is mixed into the second portion of carrier fluid at a speed of 100 RPM or less, for example 90 RPM or less, for example 80 rpm or RPM, for example 70 RPM or less, for example 60 RPM or less, for example 50 RPM or less to ensure complete dispersion before the precipitation of the polymer resin is effected. In some examples, following dispersion of the pigment particles at a low speed, the rate of mixing may be increased to less than 100 RPM, for example less than 90 RPM, for example less than 80 RPM, for example 70 RPM or less. In some examples, following addition of the dispersion of the pigment particles, the rate of mixing may be lowered to less than 500 RPM, for example less than 400 RPM, for example less than 300 RPM, for example less than 200 RPM, for example 100 RPM or less, for example less than 90 RPM, for example less than 80 RPM, for example less than 70 RPM, for example less than 60 RPM, for example 50 RPM or less while the first precipitation is effected.

In some examples, once the dispersion of pigment particles has been added to the second portion of carrier fluid and the pigment particles with inorganic spacer particles adhered thereto are fully dispersed, the system is cooled. In some examples, the system is at an uncontrolled rate until it is at a temperature of about 10° C. higher than the cloud point of the system. Thereafter, in some examples, the system is then cooled at a controlled rate.

In some examples, cooling at an uncontrolled date comprises cooling at a rate of at least or about 20° C./hour. Such cooling rates can be achieved through the use of heat exchangers and suitable refrigerants. In some examples, the temperature of the carrier fluid is lowered through the cloud point of the system through a controlled cooling process at a given rate. For example, the temperature of the carrier fluid may be lowered at a rate of less than 7° C. per hour, for example less than 6° C. per hour, for example less than 5° C. per hour, for example less than 4° C. per hour, for example 3° C. per hour. In some examples, cooling at a controlled rate continues until the temperature of the carrier fluid is about 5° C. to 10° C. lower than the cloud point. Thereafter, cooling to room temperature may be continued at an uncontrolled rate, of at least or about 20° C./hour.

In some examples, once the solution has cooled to below the cloud point temperature and the polymer resin has precipitated, the system is then reheated to above the cloud point of the solution, for example to at least 5° C. above the cloud point of the solution, for example at least 10° C. above the cloud point of the solution, at least 15° C. above the cloud point temperature of the solution, at least 20° C. above the cloud point temperature of the solution. In some examples, the system is then reheated to about 100° C. The reheating of the solution to above the cloud point followed by a second precipitation is thought to improve the final encapsulation of the cyan pigment particle by the polymer resin.

In some examples, the second precipitation is effected through controlled cooling through the cloud point of the polymer resin-carrier fluid system. For example, the controlled cooling at a rate of less than 7° C./hour, for example a rate of 3° C./hour, may be carried out beginning at a temperature of 5° C. to 10° C. above the cloud point of the solution and continued until a temperature of at least 5° C. to 10° C. below the cloud point of the solution. In some examples, once the temperature has been lowered in a controlled manner to at least 5° C. to 10° C. below the cloud point of the solution, the system is then cooled at an uncontrolled rate to room temperature. In some examples, the second precipitation is effected through cooling at an uncontrolled rate (for example at a rate of 20° C./hour) to at least 5° C. below the cloud point of the solution, followed by controlled cooling at a slower cooling rate, for example at a rate of less than 7° C. per hour, for example less than 6° C. per hour, for example less than 5° C. per hour, for example less than 4° C. per hour, for example 3° C. per hour until precipitation of the resin and concomitant encapsulation of the cyan pigment particle is complete.

In some examples, following the second precipitation of the resin from the carrier fluid, the composition comprising polymer resin-coated cyan pigment particles in carrier fluid may be subjected to a high shear treatment. The high shear process may involve stirring the mixture, for example at a high speed, for example a speed of at least 1000 RPM, in some examples at least 5000 RPM, in some examples at least 5000 RPM, in some examples at least 10,000 RPM, in some examples at least 15,000 RPM, in some examples at least 20,000. The stirring may be carried out for a period of at least 30 seconds, in some examples at least 1 minute in some examples at least 2 minutes. In some examples, the stirring may be carried out at least 10,000 RPM for at least 2 minutes, in some examples at least 20,000 RPM for at least 2 minutes.

In some examples, the composition comprising polymer resin-coated cyan pigment particles in carrier fluid obtained from the method is suitable for use as a printing composition without further treatment, in particular without a grinding treatment. In some examples, the composition comprising polymer resin-coated cyan pigment particles in carrier fluid obtained from the method is subjected to a grinding step of no more than 4 hours at 45° C. at 250 rpm. In some examples, a charge director is added to the composition only after precipitation is completed, and the composition with added charge director is subjected to a grinding step of no more than 4 hours at 45° C. at 250 rpm.

In some examples, the composition comprising polymer resin-coated cyan pigment particles in carrier fluid obtained from the method is diluted with additional carrier liquid to a required pigment loading, for example at least 15 wt. %, for example at least 20 wt. %, at least 25 wt. %, at least 30 wt. % based on the total solids of the composition.

While the methods described herein are directed to producing a liquid electrophotographic ink composition, it will be understood that such methods are equally applicable to the production of a polymer encapsulated pigment particle as also described herein.

Thus, there is also described a method for producing a cyan pigment, the method comprising:
dispersing in a first portion of carrier fluid cyan pigment particles and inorganic spacer particles, the inorganic spacer particles having a particle size (d50) of 0.1 μm or less, such that the inorganic spacer particles adhere to the cyan pigment particles;
heating a polymer resin in a second portion of carrier fluid to dissolve the polymer resin;
adding the dispersion of the cyan pigment particles having the inorganic spacer particles adhered thereto in the first portion of carrier fluid to the dissolved polymer resin in the second portion of carrier fluid;
cooling the carrier fluid at a controlled rate to effect precipitation of the polymer resin from the carrier fluid such that a coating of the resin is formed on the cyan pigment particles having the inorganic spacer particles adhered thereto, thereby producing the cyan pigment.

The particular steps of the above mentioned method for producing a cyan pigment may be as described for the methods for producing the ink composition.

Liquid Electrophotographic Composition

In some examples, the composition resulting from the precipitation of the resin from the carrier fluid is suitable for use as or is converted to an electrostatic ink composition, before or after the optional high shear treatment step. The electrostatic ink composition may be a dry toner or a liquid toner composition. The electrostatic ink composition may comprise coated particles comprising the resin, the cyan pigment particles and the inorganic spacer particles. In some examples, a particle comprises cyan pigment particles with the inorganic spacer particles adhered thereto, having a coating of the resin thereon. In some examples, the coating of resin on the pigment particles partially or completely encapsulates the cyan pigment particles and the inorganic spacer particles. In some examples, the electrostatic ink composition may comprise particles comprising the resin, the cyan pigment particles and the inorganic spacer particles, wherein at least some of the cyan pigment particles with the inorganic spacer particles are completely encapsulated by the coating of the resin. In some examples, the composition resulting from the precipitation of the resin from the liquid carrier is suitable for use as or is converted to an electrostatic ink composition by removing the liquid to leave dry particles, comprising the resin and the coated cyan pigment particles and inorganic spacer particles. The particles may be capable of developing a charge from the nature of the resin, e.g. if the resin has acidic side groups, to become chargeable particles. In some examples, an electrostatic ink composition may comprise a charge director. In some examples, a charge director may be present in the carrier liquid before precipitation of the resin. In some examples, a charge director is added during or after precipitation of the resin. In some examples, a charge director is added to the composition resulting from the precipitation of the resin from the liquid carrier to convert it to an electrostatic ink composition.

In some examples, the liquid electrophotographic ink composition comprises:
a carrier fluid; and
a cyan pigment particle dispersed in the carrier fluid;
wherein the cyan pigment particle comprises a cyan pigment and an inorganic spacer particle having a particle size (d50) of 0.1 μm or less associated with the cyan pigment; and
a polymer resin encapsulating the cyan pigment and inorganic spacer particle.

In some examples, the encapsulated cyan pigment particles, constitute 60% or less by weight of the solids in the electrostatic ink composition or composition resulting from the method, for example 55% or less by weight of the solids in the electrostatic ink composition or composition resulting from the method, for example 50% or less by weight of the solids in the electrostatic ink composition or composition resulting from the method, for example 40% or less by weight of the solids in the electrostatic ink composition or composition resulting from the method, for example 35% or less by weight of the solids in the electrostatic ink composition or composition resulting from the method, for example 30% or less by weight of the solids in the electrostatic ink composition or composition resulting from the method, for example 25% or less by weight of the solids in the electrostatic ink composition or composition resulting from the method, which may be an electrostatic ink composition.

In some examples, a printed ink composition comprising the encapsulated pigment particle has an optical density of at least 1, for example at least 1.1, for example at least 1.2, for example at least 1.3, for example at least 1.4, for example at least 1.5.

In some examples, the cyan liquid electrophotographic ink composition is produced directly from the methods described herein and is usable as a printing composition. In one example, the carrier fluid used in the resin precipitation process is or comprises the carrier fluid used for the pigment resin coated particles in a printing process. Using in the precipitation step a carrier fluid which is also useable as the carrier fluid in a printing process allows for a reduction in manufacturing complexity and thereby increases the efficiency of the process.

In one example, the polymer resin coated pigment particles may have a median particle size (d₅₀) of less than 40 μm, for example less than 30 μm, less than 20 μm, less than 15 μm, less than 10 μm, less than 9 μm, less than 8 μm, about 7 μm.

In one example, the cyan pigment particles having a polymer resin coating thereon may have a particular median particle size after grinding of the liquid electrophotographic composition for a given time under standard conditions. For example, the polymer resin coated cyan pigment particles may have a median particle size of less than 7 μm after grinding for 4 hours at 45° C., 250 rpm, and 40% non-volatile solids content. Alternatively, the polymer resin coated cyan pigment particles may have a median particle size of less than 4 μm after grinding for 120 minutes at 45° C., 250 rpm, and 40% non-volatile solids content.

In one example, the polymer resin coated pigment particles may have a percentage of particles having a size greater than 20 μm (“Tail 20”) of less than 20%, for example less than 15%, less than 10%, less than 9%, less than 8%, less than 7%.

In one example, the coated pigment particles having a polymer resin coating thereon may have a particular percentage of particles having a size greater than 20 μm (“Tail 20”) after grinding of the cyan liquid electrophotographic composition for a given time under standard conditions. For example, the polymer resin coated pigment particles may have a percentage of particles having a size greater than 20 μm of less than 15 after grinding for 4 hours at 45° C., 250 rpm, and 40% non-volatile solids content. Alternatively, the polymer resin coated pigment particles may have a percentage of particles having a size greater than 20 μm of less than 8% after grinding for 120 minutes at 45° C., 250 rpm, and 40% non-volatile solids content.

The grinding may be carried out on any commercial attritor, for example an S0, SD-1 or S1 attritor from Union Process. The grinding may be carried out using a metallic grinding media, or a non-metallic grinding media. The grinding media may be or comprise carbon steel, or chrome steel, or stainless steel, or steel shot. The grinding media may be or comprise alumina or other ceramic material such as glass mullite silicon carbide silicon nitride, tungsten carbide zirconium oxide, or zirconium silicate. The grinding media may be or comprise spherical or substantially spherical media, satellites or radius-end cylinders. Satellites will be understood as being substantially spherical with a protruding band around the circumference. The grinding media may be 35 mm or less in diameter, 31 mm or less in diameter, 30 mm or less in diameter, for example 26 mm or less, 25 mm or less, 15 mm or less, 12.7 mm or less in diameter, 10 mm or less, for example 9.5 mm or less, 7.9 mm or less, 5.6 mm or less, 6.4 mm or less, 3.9 mm or less, 3.2 mm or less, 2.4 mm or less, 2 mm or less, for example 1.7 mm or less, 1.4 mm or less, 1 mm or less, 1.18 mm or less, 0.7 mm or less, 0.6 mm or less, 0.5 mm or less, 0.4 mm or less, or 0.25 mm or less in diameter.

The present disclosure also relates to a method of electrostatic printing using an electrostatic ink composition as described herein, which may result from the method described herein, the electrostatic ink composition comprising resin-coated cyan pigment particles, the method comprising:
forming a latent electrostatic image on a surface;
contacting the surface with the electrostatic ink composition, such that at least some of the particles adhere to the surface to form a developed toner image on the surface, and transferring the toner image to a print substrate, in some examples, via an intermediate transfer member.

The surface on which the latent electrostatic image is formed may be on a rotating member, e.g. in the form of a cylinder. The surface on which the latent electrostatic image is formed may form part of a photo imaging plate (PIP). The intermediate transfer member may be a rotating flexible member, which may be heated, e.g. to a temperature of from 80 to 130° C. The print substrate may be or comprise a cellulosic print substrate such as paper. The cellulosic print substrate may be or comprise an uncoated cellulosic print substrate, i.e. absent of a coating of a polymeric material. The print substrate may be an acrylic print substrate, in some examples a coated acrylic print substrate, e.g. coated with a styrene-butadiene co-polymer.

### EXAMPLES

The following illustrates examples of the methods and related aspects described herein. Thus, these examples should not be considered as limitations of the present disclosure, but are merely in place to teach how to make examples of compositions of the present disclosure. As such, a representative number of compositions and their method of manufacture are disclosed herein.

### Liquid Electrophotographic Ink Compositions

Materials

Resins: Nucrel 599 and Nucrel 699 are ethylene-methacrylic acid copolymers available from DuPont. AC-5120 is an ethylene acrylic acid copolymer resin available from Honeywell.

Pigments: LIONOL BLUE FG-7351 is a blue pigment available from Toyo. Heliogen® Green D 8730 is a green pigment available form BASF.

Inorganic spacer particle: Sachtosperse® HU-N is a barium sulfate available from Huntsman.

Solvent: Isopar-L is available from Exxon-Mobil.

Charge director: VCA (aluminium di-stearate) available from Sigma-Aldrich

Preparation of Pigment Dispersion

The ingredients listed in Table 1 were mixed at room temperature for 1 hour at 5000 rpm using a high shear mixer (Ultra-Turrex® UTC-KT from IKA).

TABLE 1
Pigment Dispersion

| Component | Amount (g) |
|---|---|
| LIONOL BLUE FG-7351 | 1028 |
| Heliogen ® Green D8730 | 86 |
| Sachtosperse ® | 59 |
| Isopar L | 3700 |
| % NVS | 24 |
| Total | 4873 |

The dispersion step causes the inorganic spacer to adhere to the surface of the pigment particles.

Precipitation Process to Form Ink Composition with Coated Pigment Particles

Two ink compositions were prepared in a 22 liter reactor from Myers Mixers, using the pigment dispersion prepared above as part of the compositions set out in Table 2.

TABLE 2

| Example Ink 1 | g | Example Ink 2 | g |
|---|---|---|---|
| Nucrel 699 + 10% VCA | 9080 | Nucrel 699 | 3067 |
| (35% nvs) | | | |
| Ace | 767 | AC-5120 | 767 |
| Pigment dispersion | 4814 | Pigment dispersion | 4814 |
| Isopar-L | — | Isopar | 6173 |
| Isopar-L | 7000 | Isopar | 7000 |
| total | 21661 | total | 21822 |

The following steps were then performed:

1. Heat resin and Isopar to 100° C. and stir at 200-400 rpm till fully dissolved and the solution is clear and homogenous. When solution is clear its temperature is above the cloud point and cooling can begin.

2. First, the solution is cooled at a maximum cooling rate until the temperature is 5-10° C. above cloud point (until the temperature is approximately 75-85° C.).

3. The pigment dispersion is then added and mixed at 5000-10000 rpm while maintaining the temperature.

4. The solution is then cooled in a controlled manner through the cloud point temperature, at a cooling rate in the range between 2-7° C./hr and with a lower agitator speed (100-200 rpm). The controlled cooling is continued until the temperature is 5-10° C. lower than the cloud point temperature, by which point phase separation should be complete.

6. Once phase separation is complete, stirring/mixing is stopped and the system is cooled to room temperature at the maximum cooling rate.

7. The resulting product is 1 kg of cyan electrostatic ink composition at 40% NVS, which is then diluted to 23% NVS with additional Isopar.

The resultant ink composition (at 23% NVS) is subjected to a grinding step in an S1 Attritor at 45° C. for 2 hours (2270 g of Example Ink 1 plus 30 g VCA), or for 4 hours (Example Ink 1, already containing VCA charge director).

Reference inks are of identical composition to the respective Example inks but have been produced by a conventional grinding method in a S1 attritor at 20% NVS for 12 hours at 45° C.

Results

The following test was performed on each in order to characterize the ink before printing in press:
Particle Charge PC (Level and Spikes), Low Field Conductivity (LF), High Field Conductivity (HF) and DC (Direct Current Conductivity);

Low field conductivity is the electrical conductivity of ElectroInk measured in phmo/cm at the following conditions:
Electrical field amplitude: 5-15 V/mm
Frequency: 5-15 Hz
Temperature: 23+/−2 C

High field conductivity is the maximum electrical conductivity of ElectroInk measured in phmo/cm at the following conditions:
Electrical field pulse:
   Shape: Rectangular
   Height: 1500 V/mm
   Duration: 8 sec
   Rise time: 1 ms or less
   Ripple: 10 V/mm or less
Sampling frequency: 1000 per second
Temperature: 23+/−2 C

DC (direct current) conductivity is the average conductivity measured in phmo/cm between 6.4 and 7.2 seconds.

Particle conductivity is the difference between the High field conductivity and the low field conductivity, measured in in phmo/cm.

Particle size and tail were determined using a Malvern Mastersizer 2000.

The two compositions were also printed onto a paper substrate using an HP Indigo press, and the following properties measured:
The optical density (OD) is measured on the ink printed on paper on a 939 0°/45° portable spectrodensitometer from Xrite and is a characteristic of the color strength of the ink. It is measured by spectrometer at an angel of 45 degrees. Optical Density (OD) is given by the equation

$$OD = - Log ( \frac{Reflected Light}{Incident Light} )$$

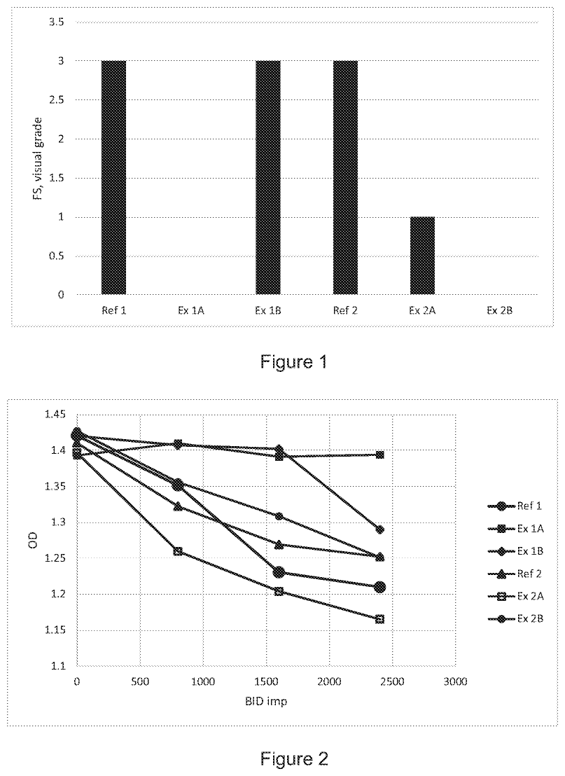

The results of the analyses are shown in Table 3 and FIGS. 1 and 2.

TABLE 3

| | Before | Particle | | | | | | | |
|---|---|---|---|---|---|---|---|---|---|
| | or After | size | Tail | Tail | | | | | |
| Example | Grinding | (d50) | 1.5% | 20% | LFC | HFC | PC | DC | OD |
| 1A | Before | 24.22 | 0.2 | 57.2 | 79 | 168 | 89 | 7.44 | 1.1 |
| 1B | After | 3.87 | 11.7 | 14.9 | 40 | 252 | 182 | 7.2 | 1.45 |
| 2A | Before | 5.345 | 1.732 | 7.28 | 72 | 96 | 24 | 4.4 | 1.3 |
| 2B | After | 6.34 | 4.98 | 7.31 | 74 | 192 | 118 | 9.2 | 1.35 |

In FIG. 1, the results of a flow streak visual comparison are presented.

As can be seen in FIG. 1, inks produced in accordance with the present disclosure, without any grinding, are far superior when printed and do not display any flow streaks when printed.

As can be seen in FIG. 2, inks produced in accordance with the present disclosure, without any grinding, demonstrate a superior optical density after 2500 impressions relative to the corresponding reference ink, and relative to an ink of the disclosure after grinding.

While the compositions, methods and related aspects have been described with reference to certain examples, those skilled in the art will appreciate that various modifications, changes, omissions, and substitutions can be made without departing from the spirit of the disclosure. It is intended, therefore, that the invention be limited by the scope of the following claims. The features of any dependent claim may be combined with the features of any of the other dependent claims or any and/or any of the independent claims.

1. A method for producing a cyan liquid electrophotographic ink composition, the method comprising:
dispersing in a first portion of carrier fluid cyan pigment particles and inorganic spacer particles, the inorganic spacer particles having a particle size (d50) of 0.1 μm or less, such that the inorganic spacer particles adhere to the cyan pigment particles;
heating a polymer resin in a second portion of carrier fluid to dissolve the polymer resin;
adding the dispersion of the cyan pigment particles having the inorganic spacer particles adhered thereto in the first portion of carrier fluid to the dissolved polymer resin in the second portion of carrier fluid;
cooling the carrier fluid at a controlled rate to effect precipitation of the polymer resin from the carrier fluid such that a coating of the resin is formed on the cyan pigment particles having the inorganic spacer particles adhered thereto, thereby producing the cyan liquid electrophotographic ink composition.

2. A method according to claim 1, wherein the inorganic spacer particles comprise barium sulfate.

3. A method according to claim 1, wherein the heated second portion of carrier fluid with dissolved polymer resin is cooled to 5 to 10° C. above its cloud point prior to the addition of the first portion of carrier fluid.

4. A method according to claim 1, wherein the carrier fluid is heated to at least 100° C. to dissolve the polymer resin.

5. A method according to claim 1, wherein the polymer resin comprises a polymer having acidic side groups.

6. A method according to claim 1, wherein the polymer resin comprises a copolymer of an alkylene monomer and a monomer selected from acrylic acid and methacrylic acid.

7. A method according to claim 1, wherein cooling the carrier fluid at a controlled rate comprises cooling to below the cloud point of the solution at a rate of no more than 7° C./hour.

8. A method according to claim 1, wherein cooling the carrier fluid at a controlled rate is performed with mixing at from 100 to 200 rpm.

9. A method according to claim 1, wherein the suspension of partially coated cyan pigment particles in the carrier fluid is reheated to above the cloud point of the solution and then cooled at a controlled rate of no more than 7° C./hour.

10. A method according to claim 1, wherein cooling the carrier fluid at a controlled rate comprises cooling the carrier fluid at a rate of no more than 5° C./hour.

11. A method according to claim 1, further comprising subjecting the polymer resin coated cyan pigment particles to high shear mixing.

12. A method according to claim 1, wherein the cyan pigment particles to be coated are dispersed in the carrier fluid with the inorganic spacer particles with high shear mixing.

13. A method according to claim 1, wherein the composition resulting from cooling at a controlled rate is suitable for use as or is converted to an liquid electrophotographic ink composition without a further step of grinding.

14. A cyan pigment particle, comprising:
a cyan pigment;
an inorganic spacer particle having a particle size (d50) of 0.1 μm or less associated with the cyan pigment; and
a polymer resin encapsulating the cyan pigment and inorganic spacer particle.

15. A cyan liquid electrophotographic ink composition comprising:
a carrier fluid; and
a cyan pigment particle according to claim 14.
